(19) United States
(12) Patent Application Publication
(10) Pub. No.: US 2020/0187264 A1
(43) Pub. Date: Jun. 11, 2020

(54) Resource Configuration For MsgA In Two-Step RACH Procedure In Mobile Communications

(71) Applicant: MediaTek Singapore Pte. Ltd., Singapore (SG)

(72) Inventors: Gilles Charbit, Cambridge (GB); Mehmet Kunt, Cambridge (GB); Pradeep Jose, Cambridge (GB)

(21) Appl. No.: 16/711,311

(22) Filed: Dec. 11, 2019

Related U.S. Application Data
(60) Provisional application No. 62/777,866, filed on Dec. 11, 2018.

(51) Int. Cl. H04W 74/08; H04W 72/04

(52) U.S. Cl. CPC H04W 74/0833; H04W 72/044

(57) ABSTRACT

Various examples and schemes pertaining to resource configuration for MsgA in a two-step random access channel (RACH) procedure in mobile communications are described. An apparatus determines a time-frequency resource for transmission of a first message in a RACH procedure with a wireless network by using a one-to-one mapping between a RACH preamble sequence number and a first message resource index with the first message resource index indicating the time-frequency resource. The apparatus then transmits the first message in the time-frequency resource to the wireless network.

### CROSS REFERENCE TO RELATED PATENT APPLICATION(S)

The present disclosure is part of a non-provisional application claiming the priority benefit of U.S. Patent Application No. 62/777,866, filed on 11 Dec. 2018, the content of which being incorporated by reference in its entirety.

### TECHNICAL FIELD

The present disclosure is generally related to mobile communications and, more particularly, to resource configuration for message A (MsgA) in a two-step random access channel (RACH) procedure in mobile communications.

### BACKGROUND

Unless otherwise indicated herein, approaches described in this section are not prior art to the claims listed below and are not admitted as prior art by inclusion in this section.

With respect to Release 16 (Rel-16) of the 3^{rd} Generation Partnership Project (3GPP) specification, Technical Report (TR) 38.889 concluded that both four-step RACH procedure and two-step RACH procedure will be supported for New Radio (NR) unlicensed spectrum (NR-U). Moreover, NR-U will support contention-free RACH (CFRA) and contention-based RACH (CBRA) for both the two-step RACH procedure and four-step RACH procedure. How time-frequency resources in the first message (MsgA) in the two-step RACH procedure are configured has yet to be defined.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is propose various concepts, solutions, schemes, techniques, designs and methods to address how time-frequency resources in MsgA in the two-step RACH procedure are configured.

In one aspect, a method may involve a processor of an apparatus determining a time-frequency resource for transmission of a first message in a RACH procedure with a wireless network by using a one-to-one mapping between a RACH preamble sequence number and a first message resource index with the first message resource index indicating the time-frequency resource. The method may also involve the processor transmitting the first message in the time-frequency resource to the wireless network.

In another aspect, an apparatus may include a transceiver and a processor coupled to the transceiver. The transceiver may be configured to wirelessly communicate with a wireless network. The processor may be configured to determine a time-frequency resource for transmission of a first message in a RACH procedure with the wireless network by using a one-to-one mapping between a RACH preamble sequence number and a first message resource index with the first message resource index indicating the time-frequency resource. The processor may be also configured to transmit, via the transceiver, the first message in the time-frequency resource to the wireless network.

It is noteworthy that, although description provided herein may be in the context of certain radio access technologies, networks and network topologies such as 5th Generation (5G), New Radio (NR), the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, narrowband (NB), narrowband Internet of Things (NB-IoT), Wi-Fi and any future-developed networking and communication technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 shows an example scenario in accordance with an implementation of the present disclosure.

FIG. 3 shows an example scenario in accordance with an implementation of the present disclosure.

FIG. 4 shows an example scenario in accordance with an implementation of the present disclosure.

FIG. 5 is a block diagram of an example communication system in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to resource configuration for MsgA in a two-step RACH procedure in mobile communications. According to the present disclosure, a number of possible solutions may be implemented separately or jointly. That is, although these possible solutions may be described below separately, two or more of these possible solutions may be implemented in one combination or another.

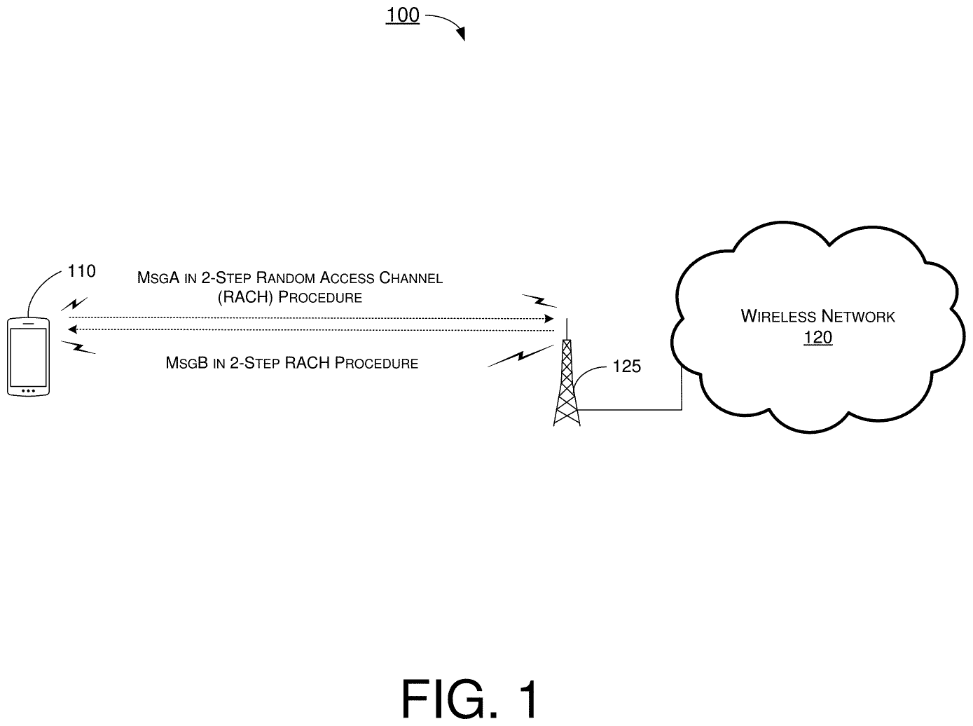

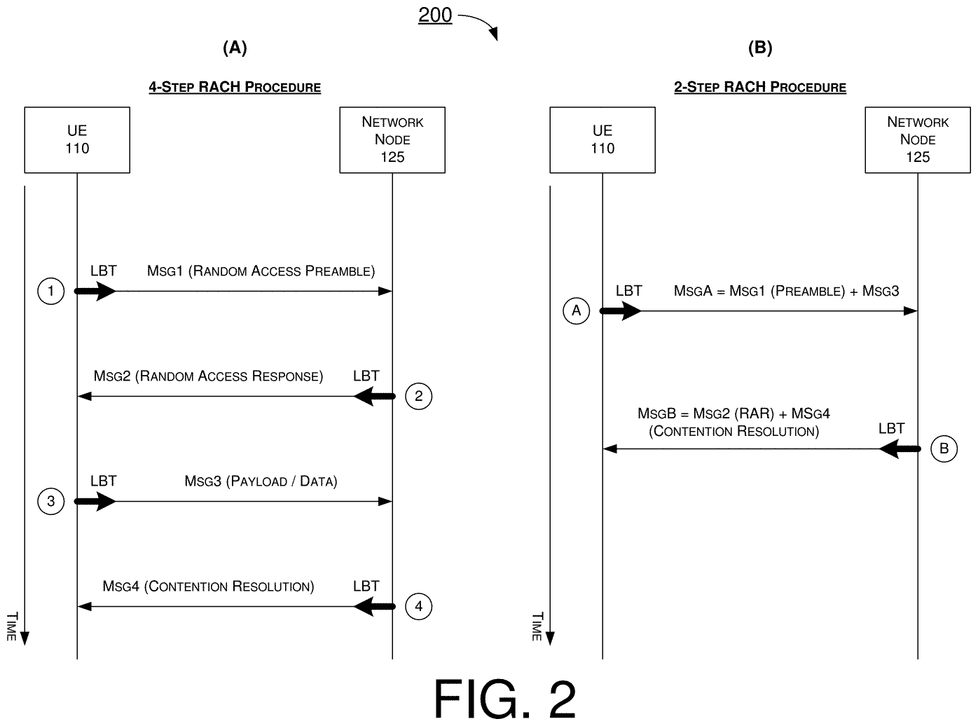

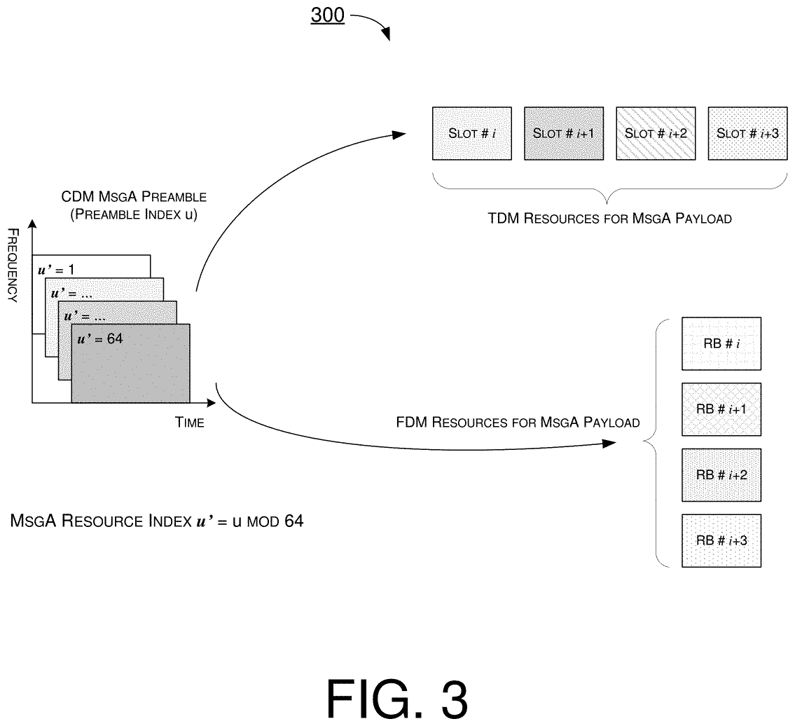

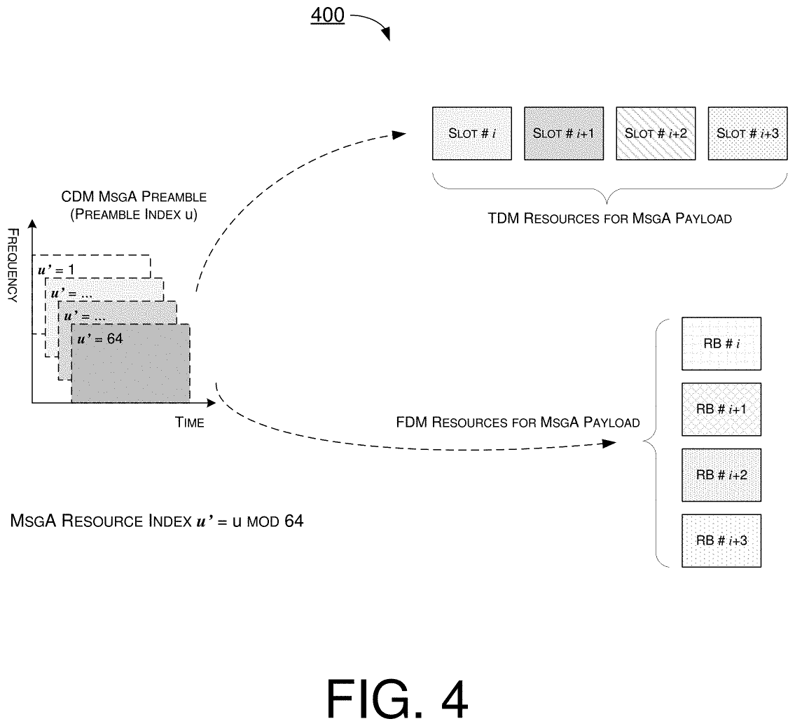

FIG. 1 illustrates an example network environment 100 in which various solutions and schemes in accordance with the present disclosure may be implemented. FIG. 2, FIG. 3 and FIG. 4 illustrate example scenarios 200, 300 and 400, respectively, in accordance with implementations of the present disclosure. Each of scenarios 200, 300 and 400 may be implemented in network environment 100. The following description of various proposed schemes is provided with reference to FIG. 1-FIG. 4.

Referring to FIG. 1, network environment 100 may involve a UE 110 in wireless communication with a wireless network 120 (e.g., a 5G NR mobile network). UE 110 may initially be in wireless communication with wireless network 120 via a base station or network node 125 (e.g., an eNB, gNB or transmit-receive point (TRP)). In network environment 100, UE 110 and wireless network 120 (via network node 125) may implement various schemes pertaining to resource configuration for message A (MsgA) in a two-step RACH procedure in mobile communications in accordance with the present disclosure, as described herein. For instance, as shown in FIG. 2, both the four-step RACH procedure and two-step RACH procedure may be implemented in network environment 100 by UE 110 and wireless network 120.

Referring to part (A) of FIG. 2, in the four-step RACH procedure, as a first step UE 110 may perform listen-before-talk (LBT) before transmitting a Msg1 (containing a random access (RA) preamble) to network node 125. In response, as a second step, network node 125 may perform LBT before transmitting a Msg2 (containing a RA response (RAR)) to UE 110. Then, as a third step, UE 110 may perform LBT before transmitting a Msg3 (containing payload such as data) to network node 125. Next, as a fourth step, network node 125 may perform LBT before transmitting a Msg4 (containing a contention resolution) to UE 110. It is noteworthy that the time dimension is not drawn to scale in part (A) of FIG. 2.

Referring to part (B) of FIG. 2, in the two-step RACH procedure, as step A, UE 110 may perform LBT before transmitting a first message or message A (MsgA) to network node 125. The MsgA may be seen as a combination of Msg1 and Msg3 of the four-step RACH procedure in that MsgA may include a RA preamble and payload. In response to receiving MsgA, at step B, network node 125 may perform LBT before transmitting a second message or message B (MsgB) to UE 110. The MsgB may be seen as a combination of Msg2 and Msg4 of the four-step RACH procedure in that MsgB may include a RA response and a contention resolution. It is noteworthy that the time dimension is not drawn to scale in part (B) of FIG. 2.

Compared to the four-step RACH procedure, the two-step RACH procedure tends to save transmit time in that the two-step RACH procedure requires fewer LBT time intervals. In particular, in the two-step RACH procedure, Msg1 and Msg3 of the four-step RACH procedure are combined in a new first message (MsgA) in the two-step RACH procedure, and Msg2 and Msg4 of the four-step RACH procedure are combined in a new second message (MsgB) in the two-step RACH procedure. In the two-step RACH procedure, timing advance (TA) is needed for transmission of MsgA payload as there is no TA command in Msg2 since Msg1 and Msg2 in the four-step RACH procedure are skipped in the two-step RACH procedure.

Accordingly, pre-configuration of time-frequency resources is needed for transmission of payload (e.g., data) as there is no uplink (UL) grant available given that Msg1 and Msg2 of the four-step RACH procedure are skipped in the two-step RACH procedure. It is noteworthy that hybrid automatic repeat request (HARQ) is applicable to Msg3 and a fixed HARQ process identifier (ID) of 0 is assigned to Msg3 in the four-step RACH procedure. For contention resolution, an idle UE may include in MsgA payload its UE ID based on the serving temporary mobile subscriber identifier (S-TMSI), and a connected UE may include in the MsgA payload its UE ID based on the cell radio network temporary identifier (C-RNTI). The MsgA may include an optional preamble part (similar to Msg1) and a transport block (TB) part containing information in Msg3.

Under a proposed scheme in accordance with the present disclosure, there may be several options with respect to the content of MsgA in the two-step RACH procedure. In a first option (or option 1) with respect to the content of MsgA, MsgA may include a preamble signal and a payload. For instance, UE 110 may select one or more time-frequency resources for transmission of the preamble signal and payload of MsgA, and UE 110 may also select a preamble index. Then, UE 110 may then transmit the preamble and payload of MsgA on the corresponding time-frequency resource(s). On the network side, network node 125 may detect the preamble of MsgA, perform channel estimation using a demodulation reference signal (DMRS), and decode the payload of MsgA. Moreover, network node 125 may perform contention resolution using the UE ID included in the payload of MsgA and then notify UE 110 using the payload of MsgB. Contention resolution may be done using the UE ID included in MsgA and MsgB payload.

FIG. 3 shows an example scenario 300 in accordance with an implementation of the first option. In the first option, a given time-frequency resource for transmission of payload of MsgA by UE 110 may be identified or otherwise correlated by a one-to-one mapping between the RACH preamble sequence number u and the time-frequency resource indicated by the MsgA resource index u′. Referring to FIG. 3, the mapping may involve time-division multiplexing (TDM), frequency-division multiplexing (FDM), or a combination of TDM and FDM. Alternatively, the mapping may involve code-division multiplexing (CDM). Under the proposed scheme, the MsgA resource index u′ may be obtained from the RACH preamble sequence number u. In the first option, the RACH preamble in MsgA may be transmitted. For instance, UE 110 may select u and determine u′ based on u (e.g., u′=u mod 64) and then transmit RA preamble.

In a second option (or option 2) with respect to the content of MsgA, MsgA may include a preamble index and/or a payload. For instance, UE 110 may select a preamble index as well as one or more time-frequency resources corresponding to the selected preamble index for transmission of payload of MsgA. UE 110 may include the preamble index in the payload of MsgA and transmit the payload of MsgA on the corresponding time-frequency resource(s). Note that, in the second option, there is no transmission of preamble as in the first option described above. On the network side, network node 125 may perform channel estimation using a DMRS, and network node 125 may also decode the payload of MsgA. Contention resolution may be done using the UE ID included in MsgA and MsgB payload.

Under the proposed scheme, in the second option, it may not be necessary to include preamble index in MsgA in an event that UE 110 already has a C-RNTI. The C-RNTI may be included in the payload of MsgA, and UE 110 may monitor a physical downlink control channel (PDCCH) for any message from network node 125 intended for the C-RNTI associated with UE 110. On the network side, network node 125 may decode the payload of MsgA, extract the C-RNTI from the payload, and address the response (e.g., MsgB) to the C-RNTI associated with UE 110.

Under the proposed scheme, in the second option, MsgA may contain the preamble index and nothing else. This scenario may apply for system information (SI) request or beam failure recovery (BFR) with CFRA, where the preamble index is reserved by wireless network 120 for a specific purpose.

FIG. 4 shows an example scenario 400 in accordance with an implementation of the second option. In the second option, a given time-frequency resource for transmission of payload of MsgA by UE 110 may be identified or otherwise correlated by a one-to-one mapping between the RACH preamble sequence number u and the time-frequency resource indicated by the MsgA resource index u′. Referring to FIG. 4, the mapping may involve TDM, FDM, or a combination of TDM and FDM. Alternatively, the mapping may involve CDM. Under the proposed scheme, the MsgA resource index u′ may be obtained from the RACH preamble sequence number u. In the second option, unlike in the first option, the RACH preamble may be skipped (not included) in MsgA. For instance, UE 110 may select u and determine u′ based on u (e.g., u′=u mod 64) but does not transmit RA preamble. The skipped RACH preamble resource may be used by one or more other UEs in its/their respective four-step RACH procedure(s).

It is noteworthy that the Release 15 (Rel-15) of the 3GPP specification NR RACH preamble resource and preamble sequence index for MsgA may be re-used or otherwise utilized in various proposed schemes in accordance with the present disclosure. With respect to re-using an NR RA preamble set, there are 64 preambles defined in each time-frequency physical random access channel (PRACH) occasion, enumerated in increasing order of first increasing cyclic shift Cᵥ of a logical root sequence and then in increasing order of the logical root sequence index, starting with the index obtained from the higher-layer parameter prach-RootSequencelndex. The logical root sequence order is cyclic. The logical index 0 is consecutive to 837 when LRA=839 and is consecutive to 137 when LRA=139 (e.g., as indicated in Technical Specification (TS) 38.211 of the 3GPP specification). The set of RA preambles, x_{u,v}(n), may be expressed in a RA preamble frequency-domain representation, y_{u,v}(n), as follows:

$$\begin{matrix}{x}_{u , v} ( n ) = {x}_{u} ( ( n + {C}_{v} ) mod {L}_{RA} ) \\ {x}_{u} ( i ) = {e}^{- j \frac{π ui ( i + 1 )}{{L}_{RA}}} , i = 0 , 1 , … , {L}_{RA} - 1\end{matrix} \to {y}_{u , v} ( n ) = {\sum }_{m = 0}^{{L}_{RA} - 1} {x}_{u , v} ( m ) \cdot {e}^{- j \frac{2 π m n}{{L}_{RA}}}$$

Here,

$${d}_{u} = \{ \begin{matrix}q & 0 \leq q < {L}_{RA} / 2 \\ {L}_{RA} - q & otherwise\end{matrix} and ( qu ) mod {L}_{RA} = 1.$$

The RACH preamble sequence number u is obtained from the logical root sequence index i. It is noteworthy that the aforementioned examples are not limitation of the scope of the present application. That is, implementation of proposed schemes of the present disclosure is not limited to the Rel-15 NR RA preamble set, and other different designs may be utilized for CBRA with LBT in NR-U.

It is also noteworthy that, under the various proposed schemes in accordance with the present disclosure, it is assumed that mapping is one-to-one between the MsgA resource index u′ and time-code-frequency resource. In case that LBT is not successful at time N using mapping between u′ and time-code-frequency resource, then UE 110 may try again with LBT and mapping between u′ and time-code-frequency resource at time N+K. From the perspective of UE 110, the mapping at time N or at time N+K ought to be one-to-one and hence it is clear what time-code-frequency resource is to be used for transmission. From the perspective of network node 125, the configuration of mapping may be different with some indication of which configuration to activate (e.g., at time N or at time N+K). In the context of frame-based equipment (FBE), where everything is done on 10 milliseconds (ms) NR radio frame and network nodes 125 only performs LBT and reserve the channel, one configuration for the mapping may be sufficient. In the context of load-based equipment (LBE), with network node 125 and UE 110 performing LBT, there may be benefit(s) with multiple configurations for the mapping. For instance, in case that LBT success is insufficient to reserve channel as needed, UE 110 may change the mapping in different chunks and/or different times to enhance likelihood of success. Activation mechanism by network node 125 may be one via medium access control (MAC) control element (CE) or downlink control information (DCI).

With respect to timing advance (TA) for the transmission of MsgA payload, in four-step RACH, network node 125 may receive Msg1 preamble and determine a TA command accordingly. For instance, network node 125 may include the TA command in Msg2 RAR, and UE 110 may use the TA command to adjust its uplink (UL) timing before transmitting Msg3 payload. In two-step RACH, network node 125 cannot provide a TA command immediately before MsgA payload is transmitted by UE 110. In option 1, the preamble is transmitted by UE 110 just before payload and there is no time for network node 125 to determine a TA command and there is no mechanism to indicate the TA command (if one is ever determined by network node 125) to UE 110. In option 2, there is no preamble transmitted by UE 110 for network node 125 to use to determine a TA command.

With respect to UL timing alignment of MsgA transmission for option 1 and option 2, TDM resources for MsgA payload and FDM resources for MsgA payload may be considered. Under the proposed schemes, for TDM resources for MsgA payload, a TA command or a valid TA may not be required. Instead, a small gap time or larger contention probability (CP) to avoid overlap of multi-user MsgA payload transmissions (e.g., from multiple UEs) and to mitigate performance loss in payload detection and decoding due to reasonable UL timing misalignment. Under the proposed schemes, for FDM resources for MsgA payload, a TA command or a valid TA may be required to avoid performance loss in multi-user MsgA payload detection/decoding due to UL timing misalignment. One solution to this issue may be similar to Rel-16 NB-IoT TA validation for early transmission in pre-configured UL resources (PUR) such as, for example and without limitation, timeAlignmentTimer and change in serving-cell reference signal received power (RSRP) measurements. Moreover, small NR-U cell with relaxed TA requirements may also be assumed.

### Illustrative Implementations

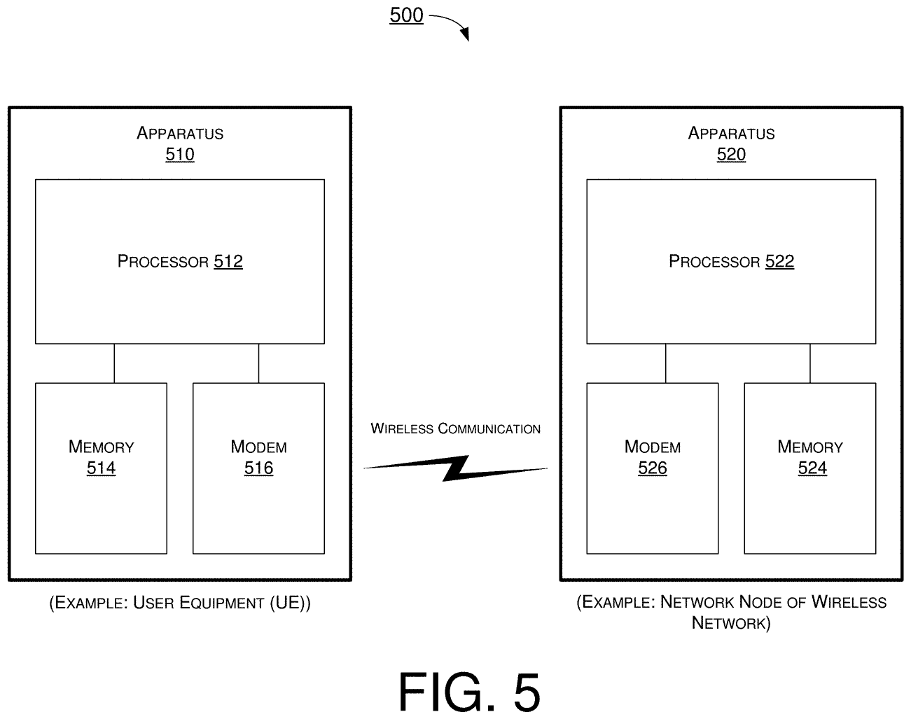

FIG. 5 illustrates an example communication system 500 having an example apparatus 510 and an example apparatus 520 in accordance with an implementation of the present disclosure. Each of apparatus 510 and apparatus 520 may perform various functions to implement schemes, techniques, processes and methods described herein pertaining to resource configuration for MsgA in a two-step RACH procedure in mobile communications, including various schemes described above as well as processes described below.

Each of apparatus 510 and apparatus 520 may be a part of an electronic apparatus, which may be a UE such as a vehicle, a portable or mobile apparatus, a wearable apparatus, a wireless communication apparatus or a computing apparatus. For instance, each of apparatus 510 and apparatus 520 may be implemented in an electronic control unit (ECU) of a vehicle, a smartphone, a smartwatch, a personal digital assistant, a digital camera, or a computing equipment such as a tablet computer, a laptop computer or a notebook computer. Each of apparatus 510 and apparatus 520 may also be a part of a machine type apparatus, which may be an IoT or NB-IoT apparatus such as an immobile or a stationary apparatus, a home apparatus, a wire communication apparatus or a computing apparatus. For instance, each of apparatus 510 and apparatus 520 may be implemented in a smart thermostat, a smart fridge, a smart door lock, a wireless speaker or a home control center. Alternatively, each of apparatus 510 and apparatus 520 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. Each of apparatus 510 and apparatus 520 may include at least some of those components shown in FIG. 5 such as a processor 512 and a processor 522, respectively. Each of apparatus 510 and apparatus 520 may further include one or more other components not pertinent to the proposed scheme of the present disclosure (e.g., internal power supply, display device and/or user interface device), and, thus, such component(s) of each of apparatus 510 and apparatus 520 are neither shown in FIG. 5 nor described below in the interest of simplicity and brevity.

In some implementations, at least one of apparatus 510 and apparatus 520 may be a part of an electronic apparatus, which may be a vehicle, a roadside unit (RSU), network node or base station (e.g., eNB, gNB or TRP), a small cell, a router or a gateway. For instance, at least one of apparatus 510 and apparatus 520 may be implemented in a vehicle-to-vehicle (V2V) or vehicle-to-everything (V2X) network, an eNodeB in an LTE, LTE-Advanced or LTE-Advanced Pro network or in a gNB in a 5G, NR, IoT or NB-IoT network. Alternatively, at least one of apparatus 510 and apparatus 520 may be implemented in the form of one or more IC chips such as, for example and without limitation, one or more single-core processors, one or more multi-core processors, or one or more CISC or RISC processors.

In one aspect, each of processor 512 and processor 522 may be implemented in the form of one or more single-core processors, one or more multi-core processors, or one or more CISC or RISC processors. That is, even though a singular term “a processor” is used herein to refer to processor 512 and processor 522, each of processor 512 and processor 522 may include multiple processors in some implementations and a single processor in other implementations in accordance with the present disclosure. In another aspect, each of processor 512 and processor 522 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 512 and processor 522 is a special-purpose machine specifically designed, arranged and configured to perform specific tasks including resource configuration for MsgA in a two-step RACH procedure in mobile communications in accordance with various implementations of the present disclosure.

In some implementations, apparatus 510 may also include a wireless transceiver 516 coupled to processor 512 and capable of wirelessly transmitting and receiving data over a wireless link (e.g., a 3GPP connection or a non-3GPP connection). In some implementations, apparatus 510 may further include a memory 514 coupled to processor 512 and capable of being accessed by processor 512 and storing data therein. In some implementations, apparatus 520 may also include a wireless transceiver 526 coupled to processor 522 and capable of wirelessly transmitting and receiving data over a wireless link (e.g., a 3GPP connection or a non-3GPP connection). In some implementations, apparatus 520 may further include a memory 524 coupled to processor 522 and capable of being accessed by processor 522 and storing data therein. Accordingly, apparatus 510 and apparatus 520 may wirelessly communicate with each other via transceiver 516 and transceiver 526, respectively.

To aid better understanding, the following description of the operations, functionalities and capabilities of each of apparatus 510 and apparatus 520 is provided in the context of an NR communication environment in which apparatus 510 is implemented in or as a wireless communication device, a communication apparatus, a UE or an IoT device (e.g., UE 110) and apparatus 520 is implemented in or as a base station or network node (e.g., network node 125).

In one aspect of resource configuration for MsgA in a two-step RACH procedure in mobile communications in accordance with the present disclosure, processor 512 of apparatus 510 may determine a time-frequency resource for transmission of a first message in a RACH procedure (e.g., two-step RACH) with a wireless network (e.g., wireless network 120) by using a one-to-one mapping between a RACH preamble sequence number and a first message resource index with the first message resource index indicating the time-frequency resource. Moreover, processor 512 may transmit, via transceiver 516, the first message (e.g., MsgA in the two-step RACH) in the time-frequency resource to the wireless network (e.g., via apparatus 520 as network node 125). Correspondingly, apparatus 520 may receive the first message in the time-frequency resource indicated by the first message resource index. Furthermore, processor 512 may receive, via transceiver 516, a second message (e.g., MsgB in the two-step RACH) from the wireless network (e.g., via apparatus 520 as network node 125).

In some implementations, the one-to-one mapping may involve TDM, FDM, or a combination of the TDM and the FDM. Alternatively, the one-to-one mapping may involve CDM.

In some implementations, the RACH preamble sequence number may be determined from a logical sequence index i and a cyclic shift Cᵥ. In some implementations, the first message resource index indicating the time-frequency resource may be further determined from the cyclic shift Cᵥ.

In some implementations, the first message may include an NR RA preamble and a payload. Alternatively, the first message may include a preamble index and a payload. Alternatively, the first message may include a payload (and nothing else). Still alternatively, the first message may include a preamble index (and nothing else).

In some implementations, in determining the time-frequency resource by using the one-to-one mapping between the RACH preamble sequence number u and the first message resource index, processor 512 may perform certain operations. For instance, processor 512 may select the RACH preamble sequence number u. Additionally, processor 512 may determine the first message resource index u′ based on the RACH preamble sequence number (e.g., as u′=u mod 64). Alternatively, or additionally, in determining the time-frequency resource by using the one-to-one mapping between the RACH preamble sequence number u and the first message resource index, processor 512 may determine the time-frequency resource by using the one-to-one mapping between the RACH preamble sequence number u and a cyclic shift Cᵥ and the first message resource index by performing certain operations. For instance, processor 512 may select the RACH preamble sequence number u and the cyclic shift Cᵥ. Additionally, processor 512 may determine the first message resource index u′ based on the RACH preamble sequence number.

In some implementations, the RACH procedure may include a two-step RACH procedure.

In some implementations, in transmitting the first message, processor 512 may transmit, via transceiver 516, the first message in a two-step RACH procedure on an NR unlicensed carrier.

### Illustrative Processes

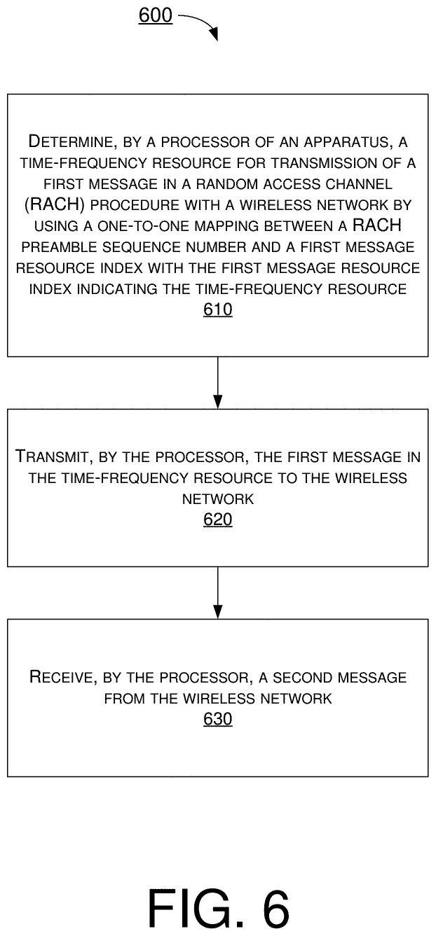

FIG. 6 illustrates an example process 600 in accordance with an implementation of the present disclosure. Process 600 may be an example implementation of the proposed schemes described above with respect to resource configuration for MsgA in a two-step RACH procedure in mobile communications in accordance with the present disclosure. Process 600 may represent an aspect of implementation of features of apparatus 510 and apparatus 520. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may be executed in the order shown in FIG. 6 or, alternatively, in a different order. Process 600 may also be repeated partially or entirely. Process 600 may be implemented by apparatus 510, apparatus 520 and/or any suitable wireless communication device, UE, RSU, base station or machine type devices. Solely for illustrative purposes and without limitation, process 600 is described below in the context of apparatus 510 as UE 110 and apparatus 520 as network node 125. Process 600 may begin at block 610.

At 610, process 600 may involve processor 512 of apparatus 510 determining a time-frequency resource for transmission of a first message in a RACH procedure (e.g., two-step RACH) with a wireless network (e.g., wireless network 120) by using a one-to-one mapping between a RACH preamble sequence number and a first message resource index with the first message resource index indicating the time-frequency resource. Process 600 may proceed from 610 to 620.

At 620, process 600 may involve processor 512 transmitting, via transceiver 516, the first message (e.g., MsgA in the two-step RACH) in the time-frequency resource to the wireless network (e.g., via apparatus 520 as network node 125). Correspondingly, apparatus 520 may receive the first message in the time-frequency resource indicated by the first message resource index. Process 600 may proceed from 620 to 630.

At 630, process 600 may involve processor 512 receiving, via transceiver 516, a second message (e.g., MsgB in the two-step RACH) from the wireless network (e.g., via apparatus 520 as network node 125).

In some implementations, the one-to-one mapping may involve TDM, FDM, or a combination of the TDM and the FDM. Alternatively, the one-to-one mapping may involve CDM.

In some implementations, the RACH preamble sequence number may be determined from a logical sequence index i and a cyclic shift Cᵥ. In some implementations, the first message resource index indicating the time-frequency resource may be further determined from the cyclic shift Cᵥ.

In some implementations, the first message may include an NR RA preamble and a payload. Alternatively, the first message may include a preamble index and a payload. Alternatively, the first message may include a payload (and nothing else). Still alternatively, the first message may include a preamble index (and nothing else).

In some implementations, in determining the time-frequency resource by using the one-to-one mapping between the RACH preamble sequence number u and the first message resource index, process 600 may involve processor 512 performing certain operations. For instance, process 600 may involve processor 512 selecting the RACH preamble sequence number u. Additionally, process 600 may involve processor 512 determining the first message resource index u′ based on the RACH preamble sequence number (e.g., as u′=u mod 64). Alternatively, or additionally, in determining the time-frequency resource by using the one-to-one mapping between the RACH preamble sequence number u and the first message resource index, process 600 may involve processor 512 determining the time-frequency resource by using the one-to-one mapping between the RACH preamble sequence number u and a cyclic shift Cᵥ and the first message resource index by performing certain operations. For instance, process 600 may involve processor 512 selecting the RACH preamble sequence number u and the cyclic shift Cᵥ. Additionally, process 600 may involve processor 512 determining the first message resource index u′ based on the RACH preamble sequence number.

In some implementations, the RACH procedure may include a two-step RACH procedure.

In some implementations, in transmitting the first message, process 600 may involve processor 512 transmitting, via transceiver 516, the first message in a two-step RACH procedure on an NR unlicensed carrier.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of an apparatus, a time-frequency resource for transmission of a first message in a random access channel (RACH) procedure with a wireless network by using a one-to-one mapping between a RACH preamble sequence number and a first message resource index with the first message resource index indicating the time-frequency resource; and
transmitting, by the processor, the first message in the time-frequency resource to the wireless network.

2. The method of claim 1, wherein the one-to-one mapping comprises time-division multiplexing (TDM), frequency-division multiplexing (FDM), code-division multiplexing (CDM), or a combination of the TDM and the FDM.

3. The method of claim 1, wherein the first message resource index indicating the time-frequency resource is further determined from a cyclic shift.

4. The method of claim 1, wherein the first message comprises a New Radio (NR) random access (RA) preamble and a payload.

5. The method of claim 1, wherein the first message comprises a preamble index and a payload.

6. The method of claim 1, wherein the first message comprises a payload.

7. The method of claim 1, wherein the first message comprises a preamble index.

8. The method of claim 1, wherein the RACH procedure comprises a two-step RACH procedure, and wherein the transmitting of the first message comprises transmitting the first message in the two-step RACH procedure on an New Radio (NR) unlicensed carrier.

9. An apparatus, comprising:
a transceiver configured to wirelessly communicate with a wireless network; and
a processor coupled to the transceiver and configured to perform operations comprising:
determining a time-frequency resource for transmission of a first message in a random access channel (RACH) procedure with the wireless network by using a one-to-one mapping between a RACH preamble sequence number and a first message resource index with the first message resource index indicating the time-frequency resource; and
transmitting, via the transceiver, the first message in the time-frequency resource to the wireless network.

10. The apparatus of claim 9, wherein the one-to-one mapping comprises time-division multiplexing (TDM), frequency-division multiplexing (FDM), code-division multiplexing (CDM), or a combination of the TDM and the FDM.

11. The apparatus of claim 9, wherein the first message resource index indicating the time-frequency resource is further determined from a cyclic shift.

12. The apparatus of claim 9, wherein the first message comprises a New Radio (NR) random access (RA) preamble and a payload.

13. The apparatus of claim 9, wherein the first message comprises a preamble index and a payload.

14. The apparatus of claim 9, wherein the first message comprises a payload.

15. The apparatus of claim 9, wherein the first message comprises a preamble index.

16. The apparatus of claim 9, wherein the RACH procedure comprises a two-step RACH procedure, and wherein, in transmitting the first message, the processor is configured to transmit the first message in a two-step RACH procedure on an New Radio (NR) unlicensed carrier.
